(19) United States
(12) Patent Application Publication
(10) Pub. No.: US 2022/0343325 A1
(43) Pub. Date: Oct. 27, 2022

(54) ASSETIZATION OF HASHTAGS

(71) Applicant: Yu Ching Hu, Inglewood, CA (US)

(72) Inventor: Yu Ching Hu, Inglewood, CA (US)

(21) Appl. No.: 17/238,241

(22) Filed: Apr. 23, 2021

(51) Int. Cl. G06Q 20/38; G06Q 20/32; G06Q 20/40; H04L 9/32

(52) U.S. Cl. CPC G06Q 20/38215; G06Q 20/3223; G06Q 20/3827; G06Q 20/401; H04L 9/3213; H04L 9/3236; G06Q 2220/00

(57) ABSTRACT

A system and method for assetizing and monetizing hashtags is disclosed. The system and method include a hardware processing device communicably coupled to a distributed ledger-based platform, wherein the hardware processing device is configured to assetize the hashtag by converting it into a non-fungible token. Further, the present disclosure also includes an additional aspect of facilitating transactions with respect to one or more rights associated with the hashtag.

### TECHNICAL FIELD

The present application relates generally to digital assets and transactions related to digital assets, and, more specifically, to a use of distributed ledgers creation of digital assets and transactions related to such digital assets.

### BACKGROUND

From time immemorial, humans have been found of owning assets, be it land, house or any other form of tangible assets. Additionally, intangible forms of assets, such as intellectual property, also have developed with time. With the advancements in technology, specifically in the field of communication technology and computer software, a new form of asset came into picture, called digital assets. These could be a piece of code, an image, a video, digital files or any other form of digital assets.

There may be various solutions for creating some forms of digital assets and monetizing the same. Additionally, some have been implemented using distributed ledgers as well. For example, Crypt® Kitties, is an Ethereum-based blockchain game created by Axiom Zen in year 2017. Crypt® Kitties allows users to collect, breed, buy and sell virtual cats in a virtual market. Each virtual cat has unique characteristics. Additionally, there may also available on certain platforms where a user may monetize the digital assets as well by offering the same for sale or for use.

However, the existing systems may lack focus on using or creating a new form of a digital asset. Moreover, there may be absence of ownership and other rights associated with such new form of digital asset for the transfer of the same. There exists a need to solve the technical problems associated with distributed ledger-based platform.

### SUMMARY

In view of the foregoing disadvantages inherent in the prior art, the general purpose of the present disclosure is to provide a new form of a digital asset, such as hashtags, to include all advantages of the prior art, and to overcome the drawbacks inherent in the prior art.

An object of the present disclosure is to provide a hashtag as a digital asset.

Another object of the present disclosure is to provide ownership and other rights associated with a hashtag and for the transfer of the same.

Yet another object of the present disclosure is to solve the technical problems associated with distributed ledger-based platform.

In view of the above objects, in one aspect, the present disclosure discloses a system and a method for assetization of a hashtag. Further, a variation of the present disclosure provides a system and a method for facilitating a transaction pertaining to the hashtag. In a primary embodiment of the present disclosure, the system and the method comprise a hardware processing device and a distributed ledger-based platform. The hardware processing device enables a user to assetize a hashtag that has been created by the user by converting it to a hashtag non-fungible token. Furthermore, the hashtag non-fungible tokens may be offered to other users for various purposes, such as right to use, sale, etc. The interested users may accept the price at which the hashtag non-fungible tokens are offered and the processor executes the transaction as per one or more transaction rules.

In one another aspect, a system for assetization of hashtags my include a hardware processing device communicably coupled via a communication network with a distributed ledger-based platform. The hardware processing device may be configured to receive a hashtag from a first user device; tokenize the hashtag into a hashtag non-fungible token using a proprietary algorithm. The hashtag non-fungible token may include details of the hashtag. Further, the hardware processing device may receive an acceptance to a transaction offer pertaining to a transaction of the hashtag non-fungible token from a second user device, separate from the first user device. The transaction of the hashtag non-fungible token may pertain to transfer of one or more rights related to the hashtag. Further, the acceptance to the transaction offer may include at least a unique identifier of a second user, separate from the first user, and a confirmation of acceptance to one or more rules of the transaction. The hardware processing device may be further configured to execute the transaction of the hashtag non-fungible token using the distributed ledger-based platform; and update the distributed ledger-based platform with a transaction update. The transaction update may include details of the transaction of the hashtag non-fungible token and details of the transfer of the one or more rights pertaining to the hashtag from the first user to the second user.

In yet another aspect, an embodiment of the present disclosure may provide a computer readable medium containing program instruction for execution on a computer system, which when executed by a computer, cause the computer to perform a method for assetization of hashtags by a hardware processing device communicably coupled via a communication network with a distributed ledger-based platform. The method includes receiving a hashtag from a first user device; tokenizing a hashtag into a hashtag non-fungible token using a proprietary algorithm. The hashtag non-fungible token may include details of the hashtag. The method may further include receiving an acceptance to a transaction offer pertaining to a transaction of the hashtag non-fungible token from a second user device, separate from the first user device. The transaction of the hashtag non-fungible token pertains to transfer of one or more rights related to the hashtag. Further, the acceptance to the transaction offer may include at least a unique identifier of a second user, separate from the first user, and a confirmation of acceptance to one or more rules of the transaction. The method further includes executing the transaction of the hashtag non-fungible token using the distributed ledger-based platform; and updating the distributed ledger-based platform with a transaction update. The transaction update may include details of the transaction of the hashtag non-fungible token and details of the transfer of the one or more rights pertaining to the hashtag from the first user to the second user.

Disclosed system and methods may facilitate a market place for one or more rights associated with a hashtag. Without limiting the scope of the disclosure, a user may offer the hashtag for sale, for use, etc. along with one or more transaction rules, at a certain price. Interested users may acquire the one or more rights associated with the hashtag by paying the certain price.

Additional aspects, advantages, features and objects of the present disclosure would be made apparent from the drawings and the detailed description of the illustrative embodiments construed in conjunction with the appended claims that follow. The systems and methods illustrated are equally applicable to virtually any communication device, including, but not limited to, computers and mobile phones.

It will be appreciated that features of the present disclosure are susceptible to being combined in various combinations without departing from the scope of the present disclosure as defined by the appended claims. Additional aspects, advantages, features and objects of the present disclosure would be made apparent from the drawings and the detailed description of the illustrative embodiments construed in conjunction with the appended claims that follow.

### BRIEF DESCRIPTION OF DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system for assetization of hashtags, in accordance with an exemplary embodiment of the present disclosure; and

FIG. 2 illustrates a flowchart detecting a method for assetization of hashtags, in accordance with an exemplary embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE EMBODIMENTS

The following description of the presently contemplated best mode of practicing the disclosure is not to be taken in a limiting sense, but is made merely for the purpose of describing the general principles of the disclosure. Embodiments of the present disclosure present technological improvements as solutions to one or more of the above-mentioned technical problems recognized by the inventor in conventional systems. The following detailed description illustrates embodiments of the present disclosure and ways in which they may be implemented. Although some modes of carrying out the present disclosure have been disclosed, those skilled in the art would recognize that other embodiments for carrying out or practicing the present disclosure are also possible.

The subject disclosure describes, among other things, illustrative embodiments for a distributed ledger-based system and a method which facilitate assetization of a hashtag. The primary embodiments of the present disclosure disclose a system and a method for assetization of the hashtag and a market place for one or more rights associated with such hashtag and also encompasses its various models and computer—aided interaction systems. Other embodiments are described in the subject disclosure.

The system may include a hardware processing device to tokenise a hashtag into a hashtag non-fungible token, creating a digital asset. The hashtag and the hashtag non-fungible token are associated with the user and thus gives a feeling of ownership of the hashtag. Further, similar to any physical asset, the user may enjoy one or more rights associated with the hashtag. Additionally, the user may monetize the same using the present system and method.

Additionally, the present disclosure facilitates a market place for one or more rights associated with a hashtag. Without limiting the scope of the disclosure, a first user may offer the hashtag for sale, for use, etc. along with one or more transaction rules, at a certain price. Interested users may acquire the one or more rights associated with the hashtag by paying a certain price. As an example, a second user is interested in using a particular hashtag. He sees using the second user device a transaction offer pertaining to the hashtag. The second user acquires the right to use the hashtag after paying the transaction price and accepting to the one or more rules of transaction.

Throughout the disclosure, one or more components of the disclosure are described as unit for the understanding of the specification. For example, a unit may include self-contained component in a hardware circuit comprising of logical gate, semiconductor device, integrated circuits or any other discrete component. The unit may also be a part of any software programme executed by any hardware entity for example processor. The implementation of unit as a software programme may include a set of logical instructions to be executed by a processor or any other hardware entity.

Additional or less units may be included without deviating from the novel art of this disclosure. In addition, each unit may include any number and combination of sub-units, and systems, implemented with any combination of hardware and/or software units. Method steps of the disclosure may be performed by one or more computer processors executing a program tangibly embodied on a computer-readable medium to perform functions of the disclosure by operating on input and generating output.

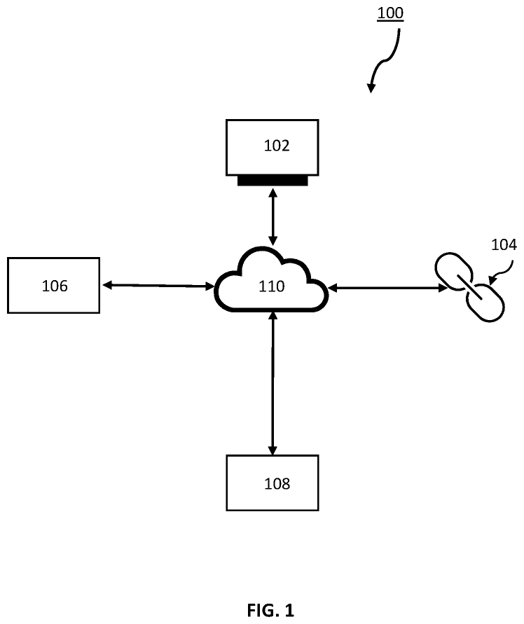

Referring now to FIG. 1, which depicts an exemplary system, such as a system 100, in accordance with an embodiment of the present disclosure. In one embodiment, the system 100 may include a hardware processing device 102 communicably coupled via a communication network 110 with a distributed ledger-based platform 104. The system 100 may also include a first user device 106 associated with a first user, and a second user device 108 associated with a second user, to communicate via the communication network 110.

In a preferred embodiment of the present disclosure, the hardware processing device 102 may be configured to receive a hashtag from the first user device 106. The hardware processing device 102 checks whether the hashtag already exists in the system 100. In case the hashtag is found to be new, the hardware processing device 102 associates that hashtag with the first user. The first user is free to offer one or more rights pertaining to the hashtag in the system 100. The first user may create a transaction offer pertaining to one or more rights associated with the hashtag which may include at least details of the hashtag non-fungible token, one or more rules of the transaction, and a price of the offer or a transaction price. For illustration, the one or more rules may be a time limit for which the hashtag may be used, number of times the hashtag may be used, etc. Further, the one or more rules of the transaction defines the type of transaction, i.e., sale, license to use, etc.

In one embodiment, the hardware processing device 102 tokenizes the hashtag into a hashtag non-fungible token using a proprietary algorithm. The hashtag non-fungible token may include at least a unique identifier of the first user and details of the hashtag. In one of the embodiments of the present disclosure, the hashtag may be tokenized into the hashtag non-fungible token using the proprietary algorithm based on one or more of ERC-721 and BEP-721 standards. However, without departing from the scope of the present disclosure, any other method may also be used for tokenizing the hashtag.

In another embodiment of the present disclosure, the hardware processing device 102 may be configured to receive an acceptance to a transaction offer pertaining to a transaction of the hashtag non-fungible token from the second user device 108. In this case, the second user is interested to acquire the one or more rights associated with the hashtag. The acceptance to the transaction offer may include details of the second user including, but not limited to, at least a unique identifier of the second user. Further, the method includes a confirmation of acceptance to one or more rules of the transaction.

Additionally, in yet another embodiment of the present disclosure, the hardware processing device 102 is configured to execute the transaction of the hashtag non-fungible token using the distributed ledger-based platform 104. Further, the distributed ledger-based platform 104 is updated with a transaction update as a new block. This new block comprises at least the details of the transaction of the hashtag non-fungible token and details of the transfer of the one or more rights pertaining to the hashtag from the first user to the second user. A transaction is said to be complete after the said update is completed in the distributed ledger-based platform 104. Since it is added as a new block onto the distributed ledger-based platform 104, the transaction update may not be modified or deleted by any user due to the inherent nature of any distributed ledger.

In the primary embodiment of the present disclosure, the core of the entire system is the hardware processing device 102 configured to facilitate the assetization of the hashtag. The term “hardware processing device” may refer to one or more individual processors, processing devices and various elements associated with a processing device that may be shared by other processing devices. Additionally, the one or more individual processors, processing devices and elements are arranged in various architectures for responding to and processing the instructions that drive the aforesaid system. Suitable processors include, by way of example, both general and special purpose microprocessors. Generally, the processor receives (reads) instructions and data from a memory (such as a read-only memory and/or a random-access memory) and writes (stores) instructions and data to the memory.

Alternatively, the hardware processing device 102 may be made by arrangement of one or more servers that includes one or more processors configured to perform various operations, for example, as mentioned earlier. Optionally, the hardware processing device 102 may include any arrangement of physical or virtual computational entities capable of performing the various operations.

Moreover, it will be appreciated that the hardware processing device 102 may be implemented by way of a single hardware server. The hardware processing device 102 may alternatively be implemented by way of a plurality of hardware servers operating in a parallel or distributed architecture. As an example, the hardware processing device 102 may include components such as a memory unit, a processor, a network adapter and the like, to store and process information pertaining to the document and to communicate the processed information to other computing components, for example, such as the first user device 106. Furthermore, the hardware processing device 102 may include one or more memory devices for storing data therein. Throughout the present disclosure, the term “hardware processing device” generally refers to a device executing an application, program, or process in a client/server relationship that responds to requests for information or services by another application, program, process or device (namely, the first user device 106, the second user device 108) on a data communication network.

The terms “user device” generally refer to electronic devices executing an application, program, or process, the devices associated with (or used by) a user (namely, a sender and a receiver), that are capable of enabling the user to perform specific tasks associated with the aforementioned system/method. Furthermore, the first user device 106 and the second user device 108 are intended to be broadly interpreted to include any electronic communication device, such as mobile phones and computers.

In all the embodiments of the present disclosure, a hashtag is a string of texts starting with the symbol “#”. Hashtags are generally used in social media posts as a clickable hyperlink. When a hashtag is clicked, it lunches a collective search to sort all the posts carrying the same hashtag out and list them in the search result pages. Further, typically, hashtags are very platform dependent, and subject to the specifications subscribed by the technical authorities of each platform.

Certain hashtags may be categorised as power hashtags wherein the hashtags have a better look and feel, have more meaning and may be for specific purposes and criteria. For illustrative purposes only, as an example, #Moon is hashtag, whereas #BloodMoon is categorised as a power hashtag since the phenomenon of a blood moon is rare, the hashtag is more powerful and meaningful. In general, the power hashtags in a sense, are special and worth the efforts or prices to pay to own it and make it work for one's purpose. In one of the embodiments of the present disclosure, the system and method are configured to enable assetization of power hashtags.

Further, in various embodiments, the system and method convert the hashtag into a nonfungible token called as the hashtag non-fungible token. A non-fungible token (NFT) is a special cryptographically-generated token that uses distributed ledger-based technology to link with a unique digital asset that may not be replicated. Typically, NFTs are: rare, i.e., the creators limit the number of tokens to increase the rarity; Indivisible, i.e., most non-fungible tokens are indivisible into smaller units. For example, a user either purchase the entire amount of the NFT, say, a digital art piece or a hashtag, or don't purchase at all; and Unique, i.e., typically, NFTs may not be replicated and may have a permanent information tab that records their uniqueness. Therefore, this information may be used as a certificate of authenticity. Various systems and methods have used NFTs for various purposes, such as gaming, digital art etc. Although the usage of NFTs has spread in various industries, they are most commonly found as a specific Ethereum token built on the ERC-721 standard. However, recently, their use is starting to spread to other blockchains like Binance Smart Chain's BEP-721 protocol.

In an additional and optional embodiment of the present disclosure, a hashtag is converted into a hashtag nonfungible token using the ERC-721 standard. ERC-721 refers to guiding standards when creating NFTs atop the Ethereum blockchain. Therefore, this is a token type that is built based on Ethereum's ERC-721 standard. In other embodiments, NFTs may live on other decentralized networks such as EOS and NEO. However, these platforms must have smart contract-capability. Smart contracts, in this case, enable the inclusion of detailed descriptions such as metadata.

In various other embodiments of the present disclosure, de-centralized database is a blockchain. In one of the embodiments of the present disclosure, the system enables transactions pertaining to the hashtag, wherein the second user requests for one or more rights associated with the hashtag by sending an acceptance to a transaction offer. The transaction is executed using one or more smart contracts, wherein having smart contracts ensures that one or more rules of the transaction are followed.

In one or more embodiments of the same disclosure, each transaction between the first user device 106 and the second user device 108 are executed using one or more smart contracts. Smart contracts are self-executing agreements between parties that have all the terms & conditions written in code, and executed automatically, depending on future signatures or trigger events. By leveraging block chain technologies, smart contracts, once appended to the block chain, may not be revoked, denied, or reversed. Smart contracts usually provide multiple functions which may be executed by simply invoking a call method on the block chain to which the said smart contract is appended to. As more and more block chains with varied processing and execution speed continue to emerge, multiple smart contracts with various functionalities are being written.

In an embodiment of the present disclosure, details of the hashtag non-fungible token and details of the transaction are added as a new block on to the blockchain and one or more transaction rules pertaining to the transaction of the hashtag are added as one or more smart contracts. Upon successful satisfaction of the one or more applicable transaction rules, the smart contract executes itself to complete the one or more transactions.

A distributed ledger-based platform 104 has a public key for a user of the system 100 which may be known to all the other users of the system 100 and a private key which is known only to the user. The use of the private key ensures that the transaction was initiated or approved by the said user itself. This adds an additional layer of authenticity to the transactions. Further, due to the inherent nature of the distributed ledger-based platform 104, such as blockchain and that of the non-fungible tokens, the present disclosure facilitates a system, such as the system 100, that may be secure and safe from threats. Thus, the ownership of one or more rights associated with the hashtag and even enjoyment of the one or more rights associated with the hashtag are protected.

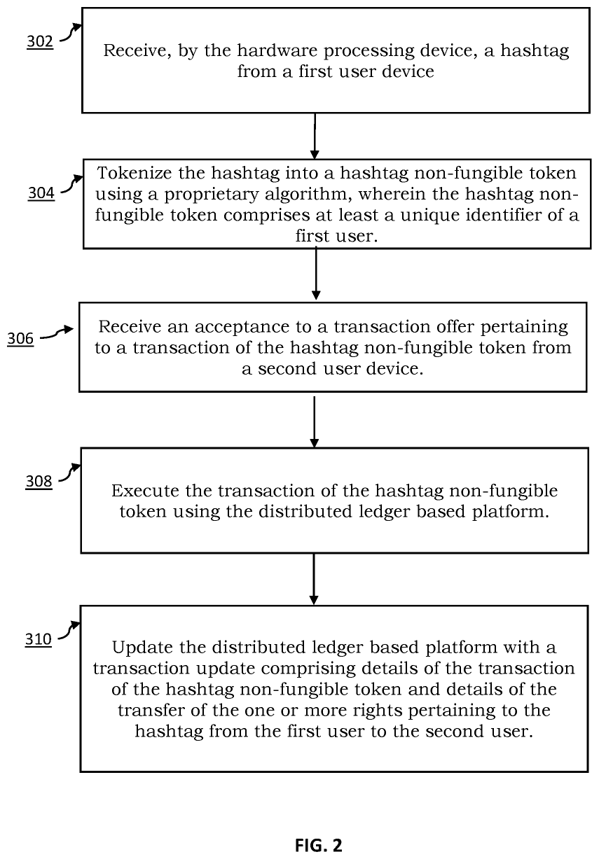

Referring now to FIG. 2, illustrated is a flowchart depicting a method for facilitating cryptocurrency transaction, in accordance with an exemplary embodiment of the present disclosure. The method is depicted as a collection of steps in a logical flow diagram, which may represent a sequence of steps that may be implemented in hardware, software, or a combination thereof, for example as aforementioned. The method is implemented by a hardware processing device, such as the hardware processing device 102, communicably coupled via a communication network, such as the communication network 110 with a distributed ledger-based platform, such as the distributed ledger-based platform 104.

As depicted, at 302, the hardware processing device 102 may receive a hashtag from a first user device, such as the first user device 106.

Further, at 304, the hashtag is tokenized into a hashtag non-fungible token using a proprietary algorithm, wherein the hashtag non-fungible token comprises details of the hashtag.

At 306, an acceptance to a transaction offer pertaining to a transaction of the hashtag non-fungible token is received by the hardware processing device 102 from a second user device, such as the second user device 108.

At 308, the transaction of the hashtag non-fungible token may be executed using the distributed ledger-based platform 104.

At 310, the distributed ledger-based platform 104 may be updated with a transaction update including details of the transaction of the hashtag non-fungible token and details of the transfer of the one or more rights pertaining to the hashtag from the first user to the second user.

In various embodiments of the present disclosure, the system and method comprise a memory device which is used to store including but not limited to the unique IDs of the users, the hashtags created by the users, details of each transactions pertaining to the hashtags. The Memory devices are suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer may generally also receive (read) programs and data from, and write (store) programs and data to, a non-transitory computer-readable storage medium, such as an internal disk (not shown) or a removable disk.

Blockchains are, by design, a back-linked list, which allow new blocks of information to be chained onto the latest block. There are no user accounts or controlling servers, so no single entity may revise the collective blockchain for their own advantage. Each time a change is made to a blockchain, it is an appended update, not a modification update, and such an update requires the full history of changes in order to validate any future proposed transaction. Each update to a blockchain should also be verified cryptographically, which typically requires a substantial amount of computer processing resources. This ensures the safety and security of the users of the system. Further, once authenticated, data may be added as a block on the blockchain and it may then be securely stored. Blockchain configurations provide secure storage for transactions which have been logged in a blockchain. The immutable structure of the blockchain is desirable for transactions pertaining to one or more rights associated with a hashtag.

In an optional embodiment of the present disclosure, the system and method may further be integrated with an existing system which acts as payment gateway using cryptocurrency transactions, wherein it enables the monetization of the hashtags. For illustration purposes, in an exemplary embodiment of the present disclosure, the system may be integrated with a Bitcoin system or an Ethereum system. A second user interested in using the hashtag offers to pay the first user to whom the hashtag belongs will get the rights to use the same once he has accepted the offer and transferred the required amount of Bitcoin or Ethereum.

In another embodiment of the same disclosure, the system and method facilitate the creation of a new cryptocurrency. The new cryptocurrency is used for transactions related to the hashtag. The user who is the owner of the hashtag may offer the one or more rights pertaining to the hashtag for a particular price. The user who is the owner of the hashtag earns the new cryptocurrency for the transactions related to the hashtag. Further, in a variation of the same embodiment, the user may fix the maximum number of rights that would be transferred or may have a limitation for using it only for a certain period of time. This creates more demand for the hashtag and for one or more rights pertaining to the hashtag.

It shall be appreciated by the person skilled in the art that such a system and method could be implemented to facilitate various alternate use cases as well. Without limiting the scope of the disclosure, one such use case is using the system and method for assetization and monetisation of memes. Memes are images or statements, which are typically humorous in nature. The meme may be converted into a non-fungible token and one or more rights associated with the meme may be offered using the system. Similarly, the system and methods may be modified to facilitate assetization and monetisation of any form of digital asset, including but not limited to digital art, a video file, an audio file, an image, an electronic file, etc.

It shall be further appreciated by the person skilled in the art that the terms “first”, “second” and the like herein do not denote any specific role or order or importance, but rather are used to distinguish one party from another.

Any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

Although an exemplary embodiment of at least one of a system and a method has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures may be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules may be sent between the modules via at least one of: a data network, the Internet, a voice network, an Internet Protocol network, a wireless device, a wired device and/or via plurality of protocols. Also, the data sent or received by any of the modules may be sent or received directly and/or via one or more of the other modules.

One skilled in the art will appreciate that a “system” could be embodied as a processor, a computer device integrated in a vehicle, a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

The description, embodiments and figures are not to be taken as limiting the scope of the claims. It should also be understood that throughout this disclosure, unless logically required to be otherwise, where a process or method is shown or described, the steps of the method may be performed in any order, repetitively, iteratively or simultaneously. At least portions of the functionalities or processes described herein may be implemented in suitable computer-executable instructions. It will be appreciated that features of the present disclosure are susceptible to being combined in various combinations and additional features may be introduced without departing from the scope of the present disclosure.

What is claimed is:

1. A system for assetization of hashtags, comprising:
a hardware processing device communicably coupled via a communication network with a distributed ledger-based platform, wherein the hardware processing device is configured to:
receive a hashtag from a first user device;
tokenize the hashtag into a hashtag non-fungible token using a proprietary algorithm, wherein the hashtag non-fungible token comprises at least details of the hashtag;
receive an acceptance to a transaction offer pertaining to a transaction of the hashtag non-fungible token from a second user device, separate from the first user device, wherein the transaction of the hashtag non-fungible token pertains to transfer of one or more rights related to the hashtag, and wherein the acceptance to the transaction offer comprises at least a unique identifier of a second user, separate from the first user, and a confirmation of acceptance to one or more rules of the transaction;
execute the transaction of the hashtag non-fungible token using the distributed ledger-based platform; and
update the distributed ledger-based platform with a transaction update, wherein the transaction update comprises details of the transaction of the hashtag non-fungible token and details of the transfer of the one or more rights pertaining to the hashtag from the first user to the second user.

2. The system of claim 1, wherein the hardware processing device enables the first user to create the transaction offer, and wherein the transaction offer comprises at least the one or more rules of the transaction, details of the hashtag non-fungible token and a transaction price.

3. The system of claim 1, wherein the hardware processing device is configured to display, using the second user device, the transaction offer pertaining to the transaction of the hashtag non-fungible token.

4. The system of claim 1, wherein the execution of the transaction is done by one or more smart contracts, based on the one or more rules of the transaction.

5. The system of claim 1, wherein the one or more rights related to the hashtag is a right to use the hashtag.

6. The system of claim 1, wherein the hardware processing device is configured to enable a platform that provides a marketplace for the hashtag whereby a plurality of users submits one or more bids to acquire the one or more rights pertaining to the hashtag.

7. The system of claim 1, wherein the first user device and the second user device is a mobile communication device.

8. The system of claim 1, wherein the hashtag tokenized into the hashtag non-fungible token using one or more of ERC-721 and BEP-721 standards.

9. The system of claim 1, wherein the distributed ledger-based platform is a blockchain.

10. The system of claim 1, wherein the transaction update is updated in the distributed ledger-based platform as a new block.

11. A method for assetization of hashtags by a hardware processing device communicably coupled via a communication network with a distributed ledger-based platform, the method comprising:
receiving a hashtag from a first user device;
tokenizing the hashtag into a hashtag non-fungible token using a proprietary algorithm, wherein the hashtag non-fungible token comprises details of the hashtag;
receiving an acceptance to a transaction offer pertaining to a transaction of the hashtag non-fungible token from a second user device, separate from the first user device, wherein the transaction of the hashtag non-fungible token pertains to transfer of one or more rights related to the hashtag, and wherein the acceptance to the transaction offer comprises at least a unique identifier of a second user, separate from the first user, and a confirmation of acceptance to one or more rules of the transaction;
executing the transaction of the hashtag non-fungible token using a distributed ledger-based platform; and
updating the distributed ledger-based platform with a transaction update, wherein the transaction update comprises details of the transaction of the hashtag non-fungible token and details of the transfer of the one or more rights pertaining to the hashtag from the first user to the second user.

12. The method of claim 11 further comprising:
creating the transaction offer using the first user device, wherein the transaction offer comprises at least the one or more rules of the transaction, details of the hashtag non-fungible token and a transaction price.

13. The method of claim 11 further comprising:
displaying, using the second user device, the transaction offer pertaining to the transaction of the hashtag non-fungible token.

14. The method of claim 11, wherein the execution of the transaction is done by one or more smart contracts, based on the one or more rules of the transaction.

15. The method of claim 11, wherein the one or more rights related to the hashtag is a right to use the hashtag.

16. The method of claim 11, wherein the hardware processing device is configured to enable a platform that provides a marketplace for the hashtag wherein a plurality of users submit one or more bids to acquire the one or more rights pertaining to the hashtag.

17. The method of claim 11, wherein the first user device and the second user device is a mobile communication device.

18. The method of claim 11, wherein the hashtag tokenized into the hashtag non-fungible token using one or more of ERC-721 and BEP-721 standards.

19. The method of claim 11, wherein the distributed ledger-based platform is a blockchain.

20. The method of claim 11, wherein the transaction update is updated in the distributed ledger-based platform as a new block.
